(19) United States
(12) Patent Application Publication
(10) Pub. No.: US 2017/0024251 A1
(43) Pub. Date: Jan. 26, 2017

(54) SCHEDULING METHOD AND APPARATUS FOR DISTRIBUTED COMPUTING SYSTEM

(71) Applicant: Tencent Technology (Shenzhen) Company Limited, Shenzhen (CN)

(72) Inventor: Jian Yi, Shenzhen (CN)

(21) Appl. No.: 15/289,773

(22) Filed: Oct. 10, 2016

Related U.S. Application Data
(63) Continuation of application No. PCT/CN2015/076128, filed on Apr. 9, 2015.

(30) Foreign Application Priority Data
Apr. 9, 2014 (CN) 201410140064.1

(51) Int. Cl. G06F 9/48; G06F 9/50

(52) U.S. Cl. CPC G06F 9/4881; G06F 9/5083

(57) ABSTRACT

A scheduling method and apparatus for a distributed computing system are disclosed. The method includes: dividing, at a first processing stage, data that needs to be processed in a task into N data blocks B_{N}; processing, if the data block B_{N} obtained after the division meets a requirement that is in a second processing stage and for task balance in the second processing stage, data of a same key according to a same function in the second processing stage; and allocating a resource to each task in the second processing stage to perform scheduling. In this way, because a data block is divided into relatively small data blocks and processing time is mostly within a controllable range, scheduling fairness can be improved; when data is divided into data blocks of relatively small capacity, sufficient concurrent jobs can also be ensured, and concurrency of the distributed computing system can be enhanced.

### PRIORITY CLAIM AND RELATED APPLICATIONS

This application is a continuation of International Application No. PCT/CN2015/076128, entitled “Scheduling Method and Apparatus for Distributed Computing System”, filed on Apr. 9, 2015, which claims priority to Chinese Patent Application No. 201410140064.1, entitled “SCHEDULING METHOD AND APPARATUS FOR DISTRIBUTED COMPUTING SYSTEM” filed on Apr. 9, 2014, both of which are incorporated by reference in their entirety.

### TECHNICAL FIELD

The present disclosure relates to the field of computer networks, and in particular, to a scheduling method and apparatus for a distributed computing system.

### BACKGROUND

A Hadoop Distributed File System (HDFS) is a most typical distributed computing system. The HDFS is a storage cornerstone of distributed computing, and the HDFS and other distributed file systems have many similar features. Basic characteristics of a distributed file system include: a single namespace for an entire cluster; data consistency, that is, suitability for a write-once-read-many model, where a file is invisible to a client before the file is successfully created; and division of a file into multiple file blocks, where each file block is allocated to a data node for storage, and a copied file block is used according to a configuration to ensure data security.

To solve issues such as processing of a production job (data analysis, Hive), a large-batch processing job (data mining and machine learning), and a small-scale interaction job (Hive query), and to ensure that in a case in which jobs submitted by different users have different requirements for computing time, storage space, data traffic, and response time, concurrent execution of jobs of multiple types can be dealt with by using a Hadoop MapReduce framework, so that the users have desirable experience, a fair scheduler algorithm is proposed in the industry. The so-called fair scheduler is mainly formed by five components, namely, a job pool manager, a load balancer, a task selector, a weight adjuster, and a job scheduling update thread. The job pool manager is mainly responsible for managing, using a pool as a unit, a job submitted by a user. This is because a quantity of jobs that participate in scheduling in each job pool is limited; therefore, each job must correspond to one unique job pool. The load balancer determines, according to load of a current cluster and load of a current task tracker node, whether to allocate a Map/Reduce task to the current task tracker node. The task selector is responsible for selecting, from a job, a Map/Reduce task for a task tracker node. The job scheduling update thread updates, every 500 ms, a schedulable job set, and invokes, during the update, the weight adjuster to update a weight of each job.

However, a fair scheduling algorithm of a fair scheduler is merely relative. For example, in an existing fair scheduling method for a distributed computing system, for example, a fair scheduling method provided by a fair scheduler in the HDFS, scheduling granularity in the method depends on the size of a data block processed by each task. That is, for a small data block, a time resource allocated during scheduling is relatively short, and for a large data block, a time resource allocated during scheduling is relatively long.

That is, in the foregoing existing fair scheduling method for a distributed computing system, when the sizes of data blocks are unbalanced, scheduling cannot be fair. For example, assuming that it is fair scheduling to allocate a time resource of ten minutes to a task of processing a data block, for a data block of 10 M, a time resource allocated by a fair scheduler during scheduling to a task responsible for processing the data block of 10 M is less than 10 minutes (for example, 8 minutes), and for a data block of 1 G, a time resource allocated by the fair scheduler during scheduling to a task responsible for processing the data block of 1 G is greater than 10 minutes (for example, 19 minutes). In this way, unfairness in such a scheduling method is reflected by the fact that the sizes of time resources allocated to tasks for processing data blocks are unequal.

### SUMMARY

Embodiments of the present disclosure provide a scheduling method and apparatus for a distributed computing system to improve fairness of a scheduling algorithm during big data processing.

An embodiment of the present disclosure provides a scheduling method for a distributed computing system, where the method includes:

dividing, at a first processing stage, data that needs to be processed in a task into N data blocks B_{N}, where N is far greater than a block quantity n of the data before the data enters the first processing stage, and the capacity of the single data block B_{N} is far less than the capacity of a single data block Bn of the data before the data enters the first processing stage;

processing, if the data block B_{N} obtained after the division meets a requirement that is in a second processing stage and for task balance in the second processing stage, data of a same key according to a same function in the second processing stage; and

allocating a resource to each task in the second processing stage to perform scheduling.

Another embodiment of the present disclosure provides a scheduling apparatus for a distributed computing system, where the apparatus includes:

a first data division module, configured to divide, at a first processing stage, data that needs to be processed in a task into N data blocks B_{N}, where N is far greater than a block quantity n of the data before the data enters the first processing stage, and the capacity of the single data block B_{N} is far less than the capacity of a single data block Bn of the data before the data enters the first processing stage;

a second processing module, configured to process, if the data block B_{N} obtained after the division meets a requirement that is in a second processing stage and for task balance in the second processing stage, data of a same key according to a same function in the second processing stage; and

a resource allocation module, configured to allocate a resource to each task in the second processing stage to perform scheduling.

It can be known from the foregoing embodiments of the present disclosure that before data enters a second processing stage, the data is divided, so that a block quantity of data blocks obtained after the division is far greater than a block quantity of data blocks before the division, and the capacity of a single data block obtained after the division is far less than the capacity of a single data block before the division. In this way, in an aspect, because a data block is divided into relatively small data blocks and processing time is mostly within a controllable range, scheduling fairness can be improved. In another aspect, although a data block B_{N} obtained after initial division cannot meet a requirement that is in the second processing stage and for task balance in the second processing stage, it can also be ensured that the capacity of each data block is the same and within a specified range when the data block B_{N} obtained after the initial division is divided again after the data block B_{N} subsequently enters an added intermediate processing stage (between a first processing stage and the second processing stage). In this way, after data has undergone the intermediate processing stage and the second processing stage, scheduling fairness can also be improved. In a third aspect, when data is divided into data blocks of relatively small capacity, time for processing a single data block is relatively short. In this way, sufficient concurrent jobs can also be ensured, and concurrency of a distributed computing system can be enhanced.

### BRIEF DESCRIPTION OF THE DRAWINGS

FIG. 1 is a basic schematic flowchart of a scheduling method for a distributed computing system according to an embodiment of the present disclosure;

FIG. 2 is a schematic diagram showing data processing in a Map stage and a Reduce stage in an existing MapReduce framework;

FIG. 3 is a schematic diagram of a logical structure of a scheduling apparatus for a distributed computing system according to an embodiment of the present disclosure;

FIG. 4 is a schematic diagram of a logical structure of a scheduling apparatus for a distributed computing system according to another embodiment of the present disclosure;

FIG. 5a is a schematic diagram of a logical structure of a scheduling apparatus for a distributed computing system according to another embodiment of the present disclosure; and

FIG. 5b is a schematic diagram of a logical structure of a scheduling apparatus for a distributed computing system according to another embodiment of the present disclosure.

### DESCRIPTION OF EMBODIMENTS

An embodiment of the present disclosure provides a scheduling method for a distributed computing system. The method includes: dividing, at a first processing stage, data that needs to be processed in a task into N data blocks B_{N}, where N is far greater than a block quantity n of the data before the data enters the first processing stage, and the capacity of the single data block B_{N} is far less than the capacity of a single data block Bn of the data before the data enters the first processing stage; processing, if the data block B_{N} obtained after the division meets a requirement that is in a second processing stage and for task balance in the second processing stage, data of a same key according to a same function in the second processing stage; and allocating a resource to each task in the second processing stage to perform scheduling. An embodiment of the present disclosure further provides a corresponding scheduling apparatus for a distributed computing system. Detailed descriptions are separately provided below.

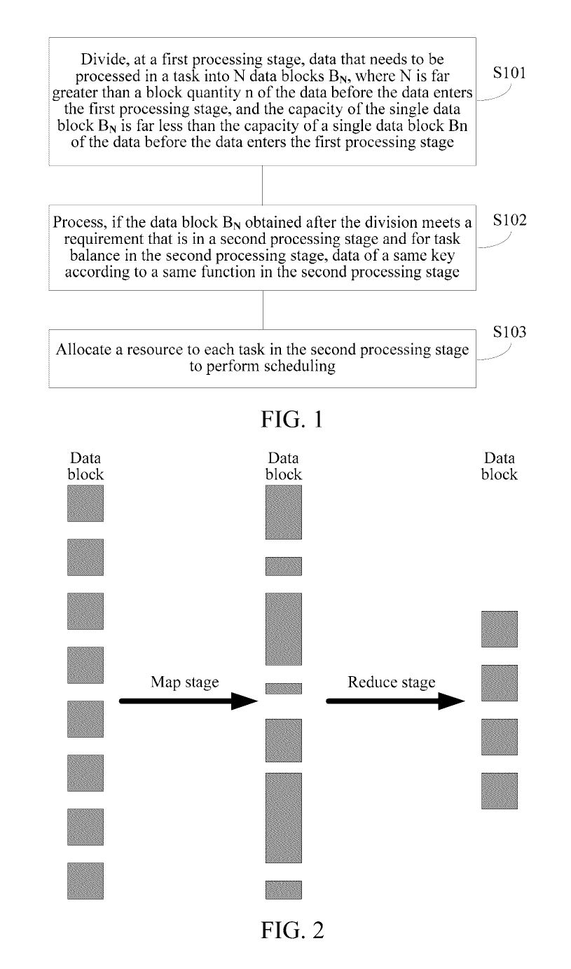

The scheduling method for a distributed computing system in the embodiment of the present disclosure is applicable to a distributed computing system such as an HDFS, and may be executed by a scheduler in the HDFS or a functional module in the HDFS. For a basic procedure of the scheduling method for a distributed computing system provided in the embodiment of the present disclosure, reference may be made to FIG. 1, which mainly includes step S101 to step S103. A detailed description is provided as follows:

S101: Divide, at a first processing stage, data that needs to be processed in a task into N data blocks B_{N}, where N is far greater than a block quantity n of the data before the data enters the first processing stage, and the capacity of the single data block B_{N} is far less than the capacity of a single data block Bn of the data before the data enters the first processing stage.

In the distributed computing system, data processing may be completed in the first processing stage and a second processing stage. For example, in the HDFS, the first processing stage may be a Map stage, the second processing stage may be a Reduce stage, and the Map stage and the Reduce stage form a MapReduce framework.

In an existing MapReduce framework, in the so-called Map stage, a Map function is specified to map a group of key-value pairs into a group of new key-value pairs, and in the so-called Reduce stage, a concurrent Reduce function is mainly specified to ensure that each of all the key-value pairs obtained by mapping shares a same key group. That is, the Map function in the Map stage accepts a key-value pair, and generates a group of intermediate key-value pairs. The MapReduce framework transmits, to a Reduce function in the Reduce stage, values of a same key in the intermediate key-value pairs generated by the Map function; and the Reduce function accepts a key and a related group of values, and combines the group of values to generate a smaller group of values (there is usually one or zero value).

A schematic diagram showing data processing in the Map stage and the Reduce stage in the existing MapReduce framework is shown in FIG. 2. It can be known from FIG. 2 that before the Map stage, the sizes of data blocks are balanced, that is, the capacity of each data block is basically equal, and the size of each data block is also ascertainable or controllable. This is because input in the Map stage comes from the distributed file system (DFS) and is relatively static data; therefore, MapTasks are balanced. Before the Reduce stage, that is, after the Map stage, data obtained after mapping is to be processed in the Reduce stage and is dynamically generated data; therefore, the sizes of data blocks are unbalanced, and the sizes of the data blocks are no longer ascertainable or controllable. Unbalance of the data blocks causes a severe consequence for data processing in the Reduce stage. A first consequence is data skew in the Reduce stage. For example, some tasks in the Reduce stage, namely, ReduceTasks, need to process data of 100 GB, some ReduceTasks only need to process data of 10 GB, and some ReduceTasks may even be idle and does not need to process any data. In a worst-case scenario, a data amount that exceeds local available storage space or a super large data amount may be allocated to a ReduceTask, and excessively long processing time is required. A second consequence is that the data skew in the Reduce stage directly causes unbalanced ReduceTasks, that is, run-time lengths of the ReduceTasks are greatly different. A third consequence is that it is difficult to execute concurrent jobs. This is because to execute concurrent jobs, scheduling switch between jobs inevitably exists; however, because a ReduceTask may need to process a large data amount and need to run for a long time, a big ReduceTask wastes a large amount of elapsed run-time and a big job may even run unsuccessfully if the ReduceTask is forced to stop. Therefore, a concurrent scheduler similar to that of a thread cannot be implemented.

To solve the foregoing problems, in the embodiment of the present disclosure, data that needs to be processed in a task may be divided into N data blocks B_{N} at the first processing stage. Specifically, for the HDFS, data that needs to be processed in a MapTask may be divided into N data blocks B_{N} at the Map stage, where N is far greater than a block quantity n of the data before the data enters the first processing stage, namely, the Map stage, and the capacity of the single data block B_{N} is far less than the capacity of a single data block Bn of the data before the data enters the first processing stage, namely, the Map stage. A block quantity of data blocks obtained after the division is far greater than a block quantity of data blocks before the division, and the capacity of a single data block obtained after the division is far less than the capacity of a single data block obtained before the data division. Advantages of this solution lie in that although the data block B_{N} obtained after initial division cannot meet a requirement that is in a second processing stage and for task balance in the second processing stage, it can also be ensured that it is simple and efficient to combine data blocks of relatively small capacity to form a data block of a specified size, and the capacity of each data block is the same and within a specified range when the data block B_{N} obtained after the initial division is divided again after subsequently the data block B_{N} enters an added intermediate processing stage (between the first processing stage and the second processing stage). In this way, after the data has undergone the intermediate processing stage and the second processing stage, scheduling fairness can also be improved.

S102: Process, if the data block B_{N} obtained after the division meets a requirement that is in a second processing stage and for task balance in the second processing stage, data of a same key according to a same function in the second processing stage.

If the data block B_{N} obtained after the division meets the requirement that is in the second processing stage and for task balance in the second processing stage, for example, the capacity of the data block B_{N} obtained after the division is already very small (for example, within a specified range), and the capacity and size of each data block B_{N} obtained after the division is equal, the data block can generally meet the requirement that is in the second processing stage and for task balance in the second processing stage.

As described above, in the Reduce stage, the Reduce function accepts a key and a related group of values, and combines the group of values to generate a smaller group of values (there is usually one or zero value). In the embodiment of the present disclosure, the data of the same key is processed according to the same function in the second processing stage, and it may be that the data of the same key is processed according to a same Reduce function in the Reduce stage.

It should be noted that if the data block B_{N} obtained after the division cannot meet the requirement that is in the second processing stage and for task balance in the second processing stage, for example, the capacity of the data blocks B_{N} obtained after the division is relatively large and the sizes of the data blocks B_{N} are unequal, data output after the first processing stage such as the Map stage is inevitably unbalanced, and as a result, scheduling fairness cannot be implemented. Unbalance of the data output after the Map stage is reflected by the fact that keys are excessively concentrated, that is, there are a large quantity of different keys, but the keys are excessively concentrated after mapping (for example, HASH), or that keys are monotonous, that is, there are a small quantity of different keys. In the foregoing case, before the data of the same key is processed in the same second processing stage, an intermediate processing stage may be added between the first processing stage and the second processing stage to divide the data block B_{N} again to obtain data blocks B′_{N}. Specifically, a balance stage may be added between the Map stage and the Reduce stage to divide the data block B_{N} again to obtain data blocks B′_{N}. After the division, the data block B′_{N} is then input in the second processing stage for example, the Reduce stage, so that data of a same key is processed according to a same function in the second processing stage. In the embodiment of the present disclosure, the balance stage is equivalent to remapping of the data output in the Map stage. Overheads are very small in this process because data does not need to be computed.

In the embodiment of the present disclosure, the capacity of each data block B_{N} obtained after the division in the first processing stage is within a preset range and the size of each data block B_{N} is equal. If the capacity and the size of each data block B_{N} obtained after the division in the first processing stage do not meet the foregoing requirement, the capacity of each data block B′_{N} obtained after the processing in the intermediate processing stage such as the balance stage is within a preset range and the size of each data block B′_{N} is equal.

S103: Allocate a resource to each task in the second processing stage to perform scheduling.

In the embodiment of the present disclosure, the capacity of each data block B_{N} obtained after the division in the first processing stage may be within a preset range and the size of each data block B_{N} may be equal. In this case, a resource may be directly allocated to each task in the second processing stage to perform scheduling. If the capacity of each data block B_{N} obtained after the division in the first processing stage is not within a preset range and the size of each data block B_{N} is not equal, the capacity of each data block B′_{N} obtained after the intermediate processing stage such as the balance stage is within a preset range, and the size of each data block B′_{N} is equal. In this case, a resource is allocated to each task in the second processing stage to perform scheduling. Specifically, step S1031 and step S1032 below are included:

S1031: Allocate a run-time slice to each task in the second processing stage.

It should be noted that the capacity of each data block B_{N} or data block B′_{N} output in the second processing stage is within a preset range and the size of each data block B_{N} or data block B′_{N} is equal, and therefore, the size of the run-time slice allocated to each task in the second processing stage is equal, for example, is controlled within 5 minutes. The time slice may be determined according to the capacity of the data block B_{N} or the data block B′_{N} and an empirical value, and the size of the time slice may not be limited in the present disclosure.

S1032: Determine, after a task in the second processing stage is completed, a next task in the second processing stage according to a scheduling rule.

In a distributed computing system such as the HDFS, a job is a task pool formed by one to multiple tasks; and tasks within a same job are equal and independent without any dependence or priority difference. A job tree is a scheduling entity above MapReduce, for example, exists in Hadoop Hive. A function of the MapReduce framework is to decompose a job into tasks and schedule a task for execution in each node in a cluster. In the embodiment of the present disclosure, the capacity of each data block B_{N} or data block B′_{N} output in the second processing stage is within a preset range and the size of each data block B_{N} or data block B′_{N} is equal; therefore, during scheduling, scheduling may be performed by following a process scheduling method. After a task in the second processing stage is completed, a next task in the second processing stage is determined according to a scheduling rule. It should be noted that after the next task is completed, a next task of the second processing stage that is determined according to the scheduling rule and previous last task do not necessarily belong to a same job.

It can be known from the scheduling method for a distributed computing system provided in the foregoing embodiment of the present disclosure that before data enters a second processing stage, the data is divided, so that a block quantity of data blocks obtained after the division is far greater than a block quantity of data blocks before the division, and the capacity of a single data block obtained after the division is far less than the capacity of a single data block before the division. In this way, in an aspect, because a data block is divided into relatively small data blocks and processing time is mostly within a controllable range, scheduling fairness can be improved. In another aspect, although a data block B_{N} obtained after initial division cannot meet a requirement that is in the second processing stage and for task balance in the second processing stage, it can also be ensured that the size of each data block is the same and within a specified range when the data block B_{N} obtained after the initial division is divided again after the data block B_{N} subsequently enters an added intermediate processing stage (between a first processing stage and the second processing stage). In this way, after data has undergone the intermediate processing stage and the second processing stage, scheduling fairness can also be improved. In a third aspect, when data is divided into data blocks of relatively small capacity, time for processing a single data block is relatively short. In this way, sufficient concurrent jobs can also be ensured, and concurrency of a distributed computing system can be enhanced.

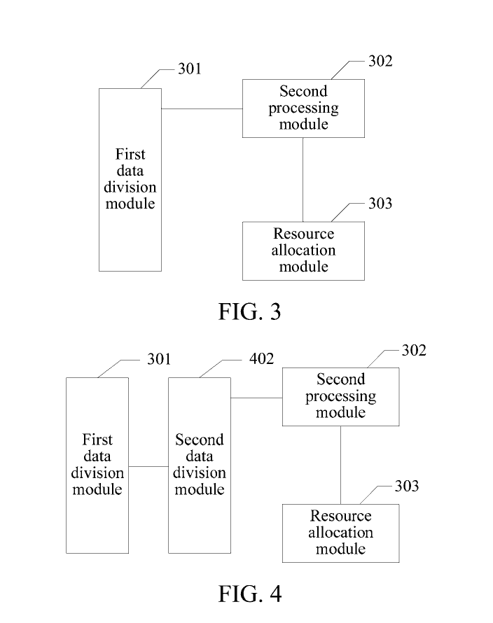

A scheduling apparatus for a distributed computing system that is in an embodiment of the present disclosure and configured to execute the foregoing scheduling method for a distributed computing system is described below. For a basic logical structure, reference may be made to FIG. 3. For ease of description, only a part related to this embodiment of the present disclosure is shown. The scheduling apparatus for a distributed computing system shown in FIG. 3 mainly includes a first data division module 301, a second processing module 302, and a resource allocation module 303. The modules are described in detail as follows:

The first data division module 301 is configured to divide, at a first processing stage, data that needs to be processed in a task into N data blocks B_{N}, where N is far greater than a block quantity n of the data before the data enters the first processing stage, and the capacity of the single data block B_{N} is far less than the capacity of a single data block Bn of the data before the data enters the first processing stage.

The second processing module 302 is configured to process, if the data block B_{N} obtained after the division meets a requirement that is in a second processing stage and for task balance in the second processing stage, data of a same key according to a same function in the second processing stage.

The resource allocation module 303 is configured to allocate a resource to each task in the second processing stage to perform scheduling.

In the scheduling apparatus for a distributed computing system shown in FIG. 3, the first processing stage is a Map stage of an HDFS, and the second processing stage is a Reduce stage of the HDFS.

It should be noted that in the foregoing implementation manner of the scheduling apparatus for a distributed computing system shown in FIG. 3, the division of the functional modules is merely an example for description. In an actual application, the foregoing functions may be allocated to different functional modules for implementation as required, that is, in consideration of a configuration requirement of corresponding hardware or convenience in software implementation. That is, the internal structure of the scheduling apparatus for a distributed computing system is divided into different functional modules, so as to complete all or a part of the functions described above. In addition, in an actual application, corresponding functional modules in this embodiment may be implemented by corresponding hardware, or may also be implemented by corresponding hardware executing corresponding software. For example, the first data division module may be hardware such as a first data divider that executes the step of dividing, at a first processing stage, data that needs to be processed in a task into N data blocks B_{N}, and may also be an ordinary processor or another hardware device that can execute a corresponding computer program to complete the foregoing function. For another example, the second processing module may be hardware such as a second processor that performs the function of processing, if the data block B_{N} obtained after the division meets a requirement that is in a second processing stage and for task balance in the second processing stage, data of a same key according to a same function in the second processing stage, or may also be an ordinary processor or another hardware device that can execute a corresponding computer program to complete the foregoing function (where the principle described above is applicable to the embodiments provided in this specification).

In the scheduling apparatus for a distributed computing system shown in FIG. 3, if the data block B_{N} obtained after the first data division module 301 performs division does not meet the requirement that is in the second processing stage and for task balance in the second processing stage, the scheduling apparatus for a distributed computing system shown in FIG. 3 further includes a second data division module 402. FIG. 4 shows a scheduling apparatus for a distributed computing system according to another embodiment of the present disclosure. The second data division module 402 is configured to add an intermediate processing stage between the first processing stage and the second processing stage to divide the data block B_{N} again to obtain data blocks B′_{N}.

In the scheduling apparatus for a distributed computing system shown in FIG. 3 or FIG. 4, the capacity of each data block B_{N} obtained after the division by the first data division module 301 is within a preset range and the size of each data block B_{N} is equal, and the capacity of each data block B′_{N} obtained after the division by the second data division module 402 is within a preset range and the size of each data block B′_{N} is equal.

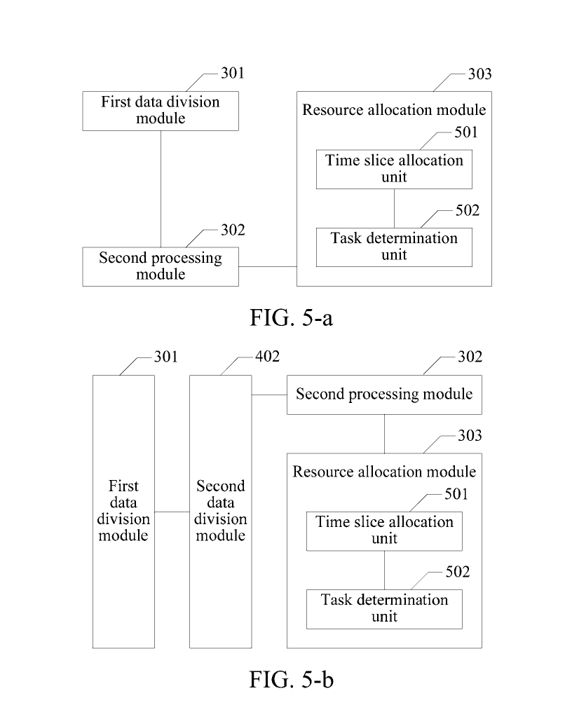

The resource allocation module 303 shown in FIG. 3 or FIG. 4 may include a time slice allocation unit 501 and a task determination unit 502. FIG. 5a or FIG. 5b shows a scheduling apparatus for a distributed computing system according to another embodiment of the present disclosure.

The time slice allocation unit 501 is configured to allocate a run-time slice to each task in the second processing stage.

The task determination unit 502 is configured to determine, after a task in the second processing stage is completed, a next task in the second processing stage according to a scheduling rule.

In the scheduling apparatus for a distributed computing system shown in FIG. 5a or FIG. 5b, the size of the run-time slice allocated by the time slice allocation unit 501 to each task in the second processing stage is equal.

An embodiment of the present disclosure further provides a fair scheduler, where the fair scheduler can be configured to implement the scheduling method for a distributed computing system provided in the foregoing embodiment. Specifically, the fair scheduler may include components such as a memory that has one or more computer readable storage media, and a processor that has one or more processing cores. A person skilled in the art may understand that the structure of the memory does not constitute any limitation on the fair scheduler, and the fair scheduler may include more or fewer components, or some components may be combined, or a different component deployment may be used.

The memory may be configured to store a software program and module. The processor runs the software program and module stored in the memory, to implement various functional applications and data processing. The memory may mainly include a program storage area and a data storage area. The program storage area may store an operating system, an application program required by at least one function (such as a sound playback function and an image display function), and the like. The data storage area may store data created according to use of the fair scheduler, and the like. In addition, the memory may include a high speed random access memory, and may also include a non-volatile memory such as at least one magnetic disk storage device, a flash memory, or another volatile solid-state storage device. Correspondingly, the memory may further include a memory controller, so as to control access of the processor to the memory.

Although not shown, the fair scheduler further includes a memory and one or more programs. The one or more programs are stored in the memory and configured to be executed by one or more processors. The one or more programs include instructions used to performing the following operations:

dividing, at a first processing stage, data that needs to be processed in a task into N data blocks B_{N}, where N is far greater than a block quantity n of the data before the data enters the first processing stage, and the capacity of the single data block B_{N} is far less than the capacity of a single data block Bn of the data before the data enters the first processing stage;

processing, if the data block B_{N} obtained after the division meets a requirement that is in a second processing stage and for task balance in the second processing stage, data of a same key according to a same function in the second processing stage; and

allocating a resource to each task in the second processing stage to perform scheduling.

In a second possible implementation manner provided based on the first possible implementation manner, if the data block B_{N} obtained after the division does not meet the requirement that is in the second processing stage and for task balance in the second processing stage, the memory of the fair scheduler further includes an instruction used to perform the following operation:

adding an intermediate processing stage between the first processing stage and the second processing stage to divide the data block B_{N} again to obtain data blocks B′_{N}.

In a third possible implementation manner provided based on the first or second possible implementation manner, the capacity of each data block B_{N} is within a preset range and the size of each data block B_{N} is equal, and the capacity of each data block B′_{N} is within a preset range and the size of each data block B′_{N} is equal.

In a fourth possible implementation manner provided based on the first or second possible implementation manner, the memory of the fair scheduler further includes an instruction used to perform the following operation:
allocating a run-time slice to each task in the second processing stage; and
determining, after a task in the second processing stage is completed, a next task in the second processing stage according to a scheduling rule.

In a fifth possible implementation manner provided based on the fourth possible implementation manner, the size of the run-time slice allocated to each task in the second processing stage is equal.

In a sixth possible implementation manner provided based on the first possible implementation manner, the first processing stage is a Map stage of an HDFS, and the second processing stage is a Reduce stage of the HDFS.

As another aspect, another embodiment of the present disclosure further provides a computer readable storage medium. The computer readable storage medium may be the computer readable storage medium included in the memory in the foregoing embodiment, or may also be a computer readable storage medium that exists independently and is not assembled in a fair scheduler. The computer readable storage medium stores one or more programs, and the one or more programs are used by one or more processors to execute a scheduling method for a distributed computing system. The method includes:

dividing, at a first processing stage, data that needs to be processed in a task into N data blocks B_{N}, where N is far greater than a block quantity n of the data before the data enters the first processing stage, and the capacity of the single data block B_{N} is far less than the capacity of a single data block Bn of the data before the data enters the first processing stage;

processing, if the data block B_{N} obtained after the division meets a requirement that is in a second processing stage and for task balance in the second processing stage, data of a same key according to a same function in the second processing stage; and

allocating a resource to each task in the second processing stage to perform scheduling.

In a second possible implementation manner provided based on the first possible implementation manner, if the data block B_{N} obtained after the division does not meet the requirement that is in the second processing stage and for task balance in the second processing stage, before the data of a same key is processed in the same second processing stage, the method further includes:

adding an intermediate processing stage between the first processing stage and the second processing stage to divide the data block B_{N} again to obtain data blocks B′_{N}.

In a third possible implementation manner provided based on the first or second possible implementation manner, the capacity of each data block B_{N} is within a preset range and the size of each data block B_{N} is equal, and the capacity of each data block B′_{N} is within a preset range and the size of each data block B′_{N} is equal.

In a fourth possible implementation manner provided based on the first or second possible implementation manner, the allocating a resource to each task in the second processing stage to perform scheduling includes:

allocating a run-time slice to each task in the second processing stage; and

determining, after a task in the second processing stage is completed, a next task in the second processing stage according to a scheduling rule.

In a fifth possible implementation manner provided based on the fourth possible implementation manner, the size of the run-time slice allocated to each task in the second processing stage is equal.

In a sixth possible implementation manner provided based on the first possible implementation manner, the first processing stage is a Map stage of an HDFS, and the second processing stage is a Reduce stage of the HDFS.

It should be noted that because content such as information interaction between and execution processes of the modules/units of the foregoing apparatus is based on ideas that are the same as that in the method embodiment of the present disclosure, and technical effects thereof are the same as that in the method embodiment of the present disclosure, for specific content, reference may be made to the description in the method embodiment of the present disclosure, and a detailed description is no longer provided again herein.

A person of ordinary skill in the art may understand that all or some of the steps of the methods in the embodiments may be implemented by a program instructing related hardware. The program may be stored in a computer readable storage medium. The storage medium may include: a read-only memory (ROM), a random access memory (RAM), a magnetic disk, or an optical disc.

The scheduling method and apparatus for a distributed computing system provided in the embodiments of the present disclosure are described in detail above. Although the principles and implementation manners of the present disclosure are described by using specific examples in this specification, the descriptions of the embodiments are merely intended to help understand the method and core ideas of the present disclosure. Meanwhile, a person of ordinary skill in the art may make modifications to the specific implementation manners and application scope according to the ideas of the present disclosure. In conclusion, the content of this specification should not be construed as a limitation on the present disclosure.

What is claimed is:

1. A scheduling method for a distributed computing system, performed at a terminal computer having one or more processors and one or more memories for storing programs to be executed by the one or more processors, the method comprising:
dividing, at a first processing stage, data that needs to be processed in a task into N data blocks B_{N}, wherein N is far greater than a block quantity n of the data before the data enters the first processing stage, and the capacity of a single data block B_{N} is far less than the capacity of a single data block Bn of the data before the data enters the first processing stage;
processing, if the data block B_{N} obtained after the division meets a requirement that is in a second processing stage and for task balance in the second processing stage, data of a same key according to a same function in the second processing stage; and
allocating a resource to each task in the second processing stage to perform scheduling.

2. The method according to claim 1, wherein if the data block B_{N} obtained after the division does not meet the requirement that is in the second processing stage and for task balance in the second processing stage, before the data of a same key is processed in the same second processing stage, the method further comprises:
adding an intermediate processing stage between the first processing stage and the second processing stage to divide the data block B_{N} again to obtain data blocks B′_{N}.

3. The method according to claim 1, wherein the capacity of each data block B_{N} is within a preset range and the size of each data block B_{N} is equal, and the capacity of each data block B′_{N} is within a preset range and the size of each data block B′_{N} is equal.

4. The method according to claim 1, wherein the allocating a resource to each task in the second processing stage to perform scheduling comprises:
allocating a run-time slice to each task in the second processing stage; and
determining, after a task in the second processing stage is completed, a next task in the second processing stage according to a scheduling rule.

5. The method according to claim 4, wherein the size of the run-time slice allocated to each task in the second processing stage is equal.

6. The method according to claim 1, wherein the first processing stage is a Map stage of a Hadoop Distributed File System (HDFS), and the second processing stage is a Reduce stage of the HDFS.

7. A scheduling apparatus for a distributed computing system, performed at a terminal computer having one or more processors and one or more memories for storing programs to be executed by the one or more processors, the apparatus comprising:
a first data division module, configured to divide, at a first processing stage, data that needs to be processed in a task into N data blocks B_{N}, wherein N is far greater than a block quantity n of the data before the data enters the first processing stage, and the capacity of a single data block B_{N} is far less than the capacity of a single data block Bn of the data before the data enters the first processing stage;
a second processing module, configured to process, if the data block B_{N} obtained after the division meets a requirement that is in a second processing stage and for task balance in the second processing stage, data of a same key according to a same function in the second processing stage; and
a resource allocation module, configured to allocate a resource to each task in the second processing stage to perform scheduling.

8. The apparatus according to claim 7, wherein if the data block B_{N} obtained after the division by the first data division module does not meet the requirement that is in the second processing stage and for task balance in the second processing stage, the apparatus further comprises:
a second data division module, configured to add an intermediate processing stage between the first processing stage and the second processing stage to divide the data block B_{N} again to obtain data blocks B′_{N}.

9. The apparatus according to claim 7, wherein the capacity of each data block B_{N} is within a preset range and the size of each data block B_{N} is equal, and the capacity of each data block B′_{N} is within a preset range and the size of each data block B′_{N} is equal.

10. The apparatus according to claim 7, wherein the resource allocation module comprises:
a time slice allocation unit, configured to allocate a run-time slice to each task in the second processing stage; and
a task determination unit, configured to determine, after a task in the second processing stage is completed, a next task in the second processing stage according to a scheduling rule.

11. The apparatus according to claim 10, wherein the size of a run-time slice allocated to each task in the second processing stage is equal.

12. The apparatus according to claim 7, wherein the first processing stage is a Map stage of a Hadoop distributed file system (HDFS), and the second processing stage is a Reduce stage of the HDFS.

13. The method according to claim 2, wherein the capacity of each data block B_{N} is within a preset range and the size of each data block B_{N} is equal, and the capacity of each data block B′_{N} is within a preset range and the size of each data block B′_{N} is equal.

14. The method according to claim 2, wherein the allocating a resource to each task in the second processing stage to perform scheduling comprises:
allocating a run-time slice to each task in the second processing stage; and
determining, after a task in the second processing stage is completed, a next task in the second processing stage according to a scheduling rule.

15. The apparatus according to claim 8, wherein the capacity of each data block B_{N} is within a preset range and the size of each data block B_{N} is equal, and the capacity of each data block B′_{N} is within a preset range and the size of each data block B′_{N} is equal.

16. The apparatus according to claim 8, wherein the resource allocation module comprises:
a time slice allocation unit, configured to allocate a run-time slice to each task in the second processing stage; and
a task determination unit, configured to determine, after a task in the second processing stage is completed, a next task in the second processing stage according to a scheduling rule.

17. A computer readable storage medium, configured to store one or more programs which are used by one or more processors to execute a scheduling method for a distributed computing system, the scheduling method comprising:
dividing, at a first processing stage, data that needs to be processed in a task into N data blocks B_{N}, where N is far greater than a block quantity n of the data before the data enters the first processing stage, and the capacity of a single data block B_{N} is far less than the capacity of a single data block Bn of the data before the data enters the first processing stage;
processing, if the data block B_{N} obtained after the division meets a requirement that is in a second processing stage and for task balance in the second processing stage, data of a same key according to a same function in the second processing stage; and
allocating a resource to each task in the second processing stage to perform scheduling.
